(19) United States
(12) Patent Application Publication
(10) Pub. No.: US 2026/0102824 A1
(43) Pub. Date: Apr. 16, 2026

(54) MODULAR CUTTING TOOL

(71) Applicant: Gühring KG, Albstadt (DE)

(72) Inventors: Emin NECETIN, Sigmaringen (DE); Tim KÄPPELER, Bingen (DE); Norbert BACHMANN, Baciu / Cluj (RO)

(73) Assignee: Gühring KG, Albstadt (DE)

(21) Appl. No.: 19/358,635

(22) Filed: Oct. 15, 2025

(30) Foreign Application Priority Data
Oct. 15, 2024 (DE) 10-2024-129 925.8
Feb. 24, 2025 (EP) 25159707.6

(51) Int. Cl. B23B 27/06; B23B 51/00

(52) U.S. Cl. CPC B23B 27/065; B23B 51/0004; B23B 2260/084

(57) ABSTRACT

What is provided is a modular cutting tool (1; 40) with a base body (2) extending along a tool axis and a tool head (3) connected via a positive coupling to the base body (2), wherein the positive coupling is formed from front toothings (4), which are engaged with one another, on the base body (2) and tool head (3), which each have a plurality of radially running teeth (5), which are distributed equidistantly around the tool axis. For each front toothing (4) the tip surfaces (7) of the teeth (5) lie on a virtual inner conical surface in the tool head (3) or base body (2) with the tool axis as cone axis, and the tip surfaces (7) of the teeth (5) are rounded concavely.

The invention relates to a modular cutting tool with a base body extending along a tool axis and a tool head connected in a positive manner to the base body.

In the case of a cutting tool proposed in the EP 4201560 A1, a positive connection is achieved between a base body and a tool head by means of front toothings, which are engaged with one another, on the base body and tool head. Each of the front toothings has a plurality of teeth, which are arranged around the tool axis and which are separated from one another by tooth gaps. The tool head is axially clamped against the base body by means of a clamping screw, which passes through a through hole in the tool head and which is screwed into a threaded bore in the base body. According to the EP 4201560 A1, the tooth flanks are to form flank surfaces as stop surfaces for an engaging tooth of the other front toothing only in the tooth tip region. In terms of a simpler processing of the stop surfaces, the EP 4201560 A1 further proposes that two stop surfaces of two different teeth of a front toothing each have a common diagonally running longitudinal axis, whereby these two stop surfaces can be processed simultaneously by means of a processing tool, preferably a grinding wheel.

However, in the case of the cutting tool proposed in the EP 4201560 A1, the front toothing on the base body is formed differently than the front toothing on the tool head. Concretely, in the case of the front toothing provided on the base body, the apex surfaces of the teeth extend in a plane transversely to the tool axis, while the bottom surfaces of the tooth gaps in each case extend at an angle obliquely to the tool axis. Outlet openings of coolant channels can lie in the bottom surfaces of the tooth gaps. In the case of the front toothing provided on the tool head, in contrast, the apex surfaces of the teeth as well as the bottom surfaces of the tooth gaps in each case extend in a plane transversely to the tool axis. In the assembled state, the apex surfaces of the teeth of the front toothing of the tool head are thus spaced apart from the bottom surfaces of the tooth gaps of the front toothing of the base body, whereby coolant supplied via the coolant channels is guided in the direction of the cutting edges formed on the tool head.

The front toothings on the base body and tool head are thus formed differently. In the case of the front toothing provided on the base body, only the above-mentioned stop surfaces, i.e., partial surfaces of the tooth flanks, of two teeth can additionally be processed simultaneously by means of a processing tool. However, all remaining surfaces, i.e., the tooth apex surfaces, tooth gap bottom surfaces and partial surfaces of the tooth flanks, which adjoin the stop surfaces, of the front toothing have to be processed separately.

Based on the cutting tool known from the EP 4201560 A1, the invention is now based on the object of providing a modular cutting tool, in the case of which the axially opposite front toothings of the tool head and of the base body can be produced more easily and more economically.

This object is solved by a modular cutting tool according to claim 1. The subclaims relate to advantageous designs.

A modular cutting tool, which can be embodied, for example, as a drilling, milling, frictional or threading tool, in particular as thread milling tool, has a base body extending along a rotational or tool axis, respectively, and a tool head clamped in an axially positive manner against the base body. The positive connection between the base body and the tool head can be accomplished by means of front toothings, which are engaged with one another and which are formed in a complementary manner, on the front end portions of the base body and tool head. The front toothings each have an identical plurality of teeth, which are distributed equidistantly around the tool axis, run radially and are separated from one another by tooth gaps. The teeth and therefore also the tooth gaps lying between the teeth of each front toothing, in particular the angle bisector thereof, thus each extend in longitudinal sectional planes, which include the tool axis, of the cutting tool. In this respect, the front toothings can also be referred to as crown or Hirth toothings.

A tooth gap is the recessed region between two teeth lying next to one another in the rotational direction of the tool or circumferential direction of the tool.

In terms of a simple and economical production of the front toothings, it is provided that the tip surfaces of the teeth, i.e., the tooth tip surfaces, each lie on a (virtual) inner conical surface in the tool head or base body with the tool axis as cone axis. The cone angles of the inner cones in the tool head and base body are of identical size. The angle between an angle bisector of the tooth tip surface of a tooth and the tool axis corresponds to half the cone angle of the inner cone of a front toothing. The tooth tips thus extend obliquely to the tool axis from radially outside to radially inside at an angle, which corresponds to half the cone angle. The tooth heights of the teeth for each front toothing thus decrease from radially outside to radially inside. The tip surfaces of the teeth of the respective virtual inner conical surface are therefore rounded concavely.

The cone angle, which is measured over the tool tip, of the (virtual) inner conical surface can lie in the range of 136° to 144°, for example of 140° to 142°.

The front toothings can be generated in such a way that inner cones, which open on the front side, are initially introduced into tool head blanks and base body blanks with the tool axis as cone axis. The inner cones, i.e., the inner conical surfaces, can be manufactured by means of a machining manufacturing method, for example with the help of a contoured milling, countersinking or grinding tool, which corresponds to the inner cone, or a non-cutting manufacturing method, for example by means of eroding, without larger effort.

After the introduction of the inner cones, the front toothings can be further processed and finished in such a way that the tooth gaps are recessed by means of a further processing of the end portions of the tool head blanks and base body blanks having the inner cones. Analogously to the inner cones, the tooth gaps can also be recessed by means of a machining manufacturing method, for example with the help of a contoured milling or grinding tool, which corresponds to the opening angle of the tooth gaps, which is spanned by the tooth flanks, or a non-cutting manufacturing method, for example by means of eroding, without larger effort.

For example, a first tooth gap can be ground into the end portion of the tool head blank and base body blank, which includes the inner conical surfaces, with the help of a grinding wheel, which is guided from radially outside to radially inside at an angle obliquely to the tool axis. Due to a repeated rotation of the tool head blank or base body blank, respectively, or of the grinding wheel about the tool axis by an angular dimension corresponding to the tooth pitch and further corresponding grinding processes, the tool head blank and base body blank can finally be further processed until all tooth gaps and thus all teeth are formed. For example, three grinding processes are necessary in the case of a front toothing with three teeth, four grinding processes are necessary in the case of a front toothing with four teeth.

The remaining surfaces of the inner conical surfaces in the tool head and base body, which remain after formation of the tooth gaps, then in each case form the tip surfaces of the teeth of the front toothings, which are separated from one another by the tooth gaps. The tip surfaces of the teeth are thus rounded concavely, so as to correspond to the inner conical surface.

The front toothings can thus be manufactured easily and economically by means of methods, which can be accomplished easily from a manufacturing technology aspect.

The tooth thicknesses of the tooth tips measured at the height of the tip surfaces in the rotational direction of the tool or circumferential direction of the tool, and the tooth flanks of the teeth inevitably result by means of the tooth gap recesses, which can in particular be manufactured so that the teeth have tooth thicknesses, which are consistent from radially inside to radially outside.

The opening angle of a tooth gap spanned by the tooth flanks can lie in the range of 80° to 130° as a function of the number of teeth per front toothing.

The tooth gaps are preferably formed in such a way that the base surfaces of the tooth gaps, which in each case lie between two teeth, extend parallel to the tip surfaces of the teeth, which are received in the tooth gaps. The angle bisectors of the base surfaces of the tooth gaps of a front toothing can thus lie on a (virtual) outer conical surface in the tool head or base body with the tool axis as cone axis.

The angle bisector of the base surfaces of the tooth gaps can therefore run in opposite directions to the tooth tip surfaces obliquely to the tool axis or of a tool cross sectional plane, respectively, in such a way that the depth of the tooth gaps decreases from radially outside to radially inside. The cone angle, which is measured over the tool tip, of the (virtual) outer conical surface can lie in the range of 216° to 224°, for example of 218° to 220°.

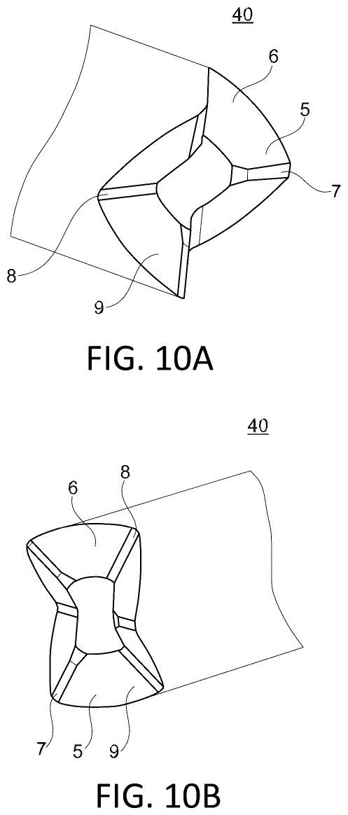

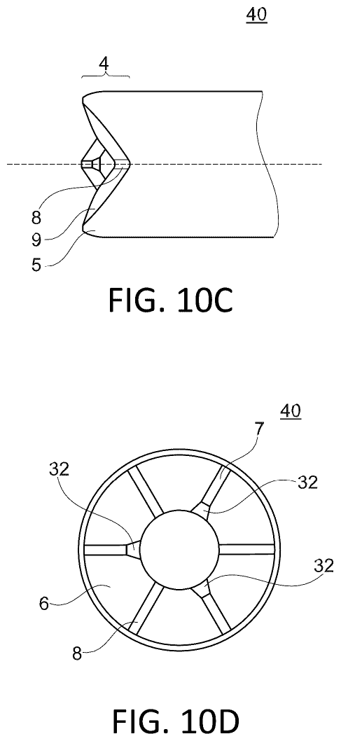

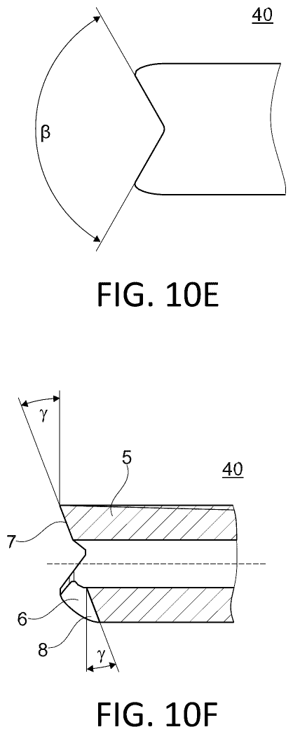

The cone angles, which are measured over the tool tip, of the inner conical surface and of the outer conical surface are preferably selected so that the inner conical surface and the outer conical surface draw an angle, the sign of which is different but the amount of which is identical, of, for example, 19° to 20°, with a plane transversely to the tool axis (tool cross sectional plane) (see the angles γ in FIG. 10F with regard to this). In other words, the inner conical surface and the outer conical surface lie obliquely to a tool cross sectional plane or to the tool axis, respectively, at an angle with an identical amount.

The base surfaces of the tooth gaps for each front toothing can furthermore be rounded concavely. In this case, the joining gaps formed between the tooth tip surfaces of the teeth and the base surfaces of the tooth gaps of the front toothings, which are engaged with one another, can be used as channels in order to guide cooling lubricant supplied via a channel system lying in the base body to the circumferential side of the tool to the outside or vice versa, e.g. in response to a vacuum application, to guide dirt and/or chips from radially outside to radially inside and to discharge them via the channel system in the base body.

The front toothings, which engage with one another, on the tool head and base body are preferably formed so that they abut against one another exclusively on the tooth flanks of their teeth, i.e., that the torque transmission and axial and radial force takes place exclusively via the tooth flanks. Due to a flat abutment only in the region of the tooth flanks, a reliable torque transmission is achieved because static indeterminacies are avoided or minimized.

The fastening of the tool head to the base body preferably takes place by means of a screw connection. For this purpose, the tool head can have a centrally located screw hole and the base body can have a threaded bore, which is coaxially aligned with the screw hole. A clamping screw, which is screwed through the screw hole into the threaded bore in the base body, then fixes the tool head to the base body.

For each front toothing, the metal-cutting tool can have an even number of, for example four, teeth or an odd number of, for example three, teeth. In the case of an even number of teeth, the teeth are distributed around the tool axis in such a way that two teeth in each case lie diametrically opposite one another. In the case of an odd number of teeth, the teeth are distributed around the tool axis in such a way that one tooth in each case lies diametrically opposite a tooth gap.

The base body and the tool head can be made of the same or different materials. For example, the base body can be made of a tool steel and the tool head can be made of solid carbide or ceramic.

Further details, features and advantages follow from the following description of preferred embodiments and on the basis of the drawings, in which:

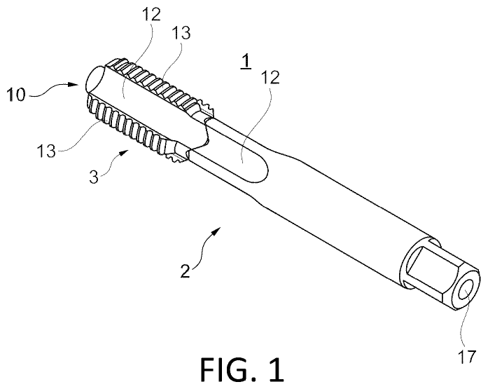

FIG. 1 shows a first embodiment of a modular metal-cutting tool;

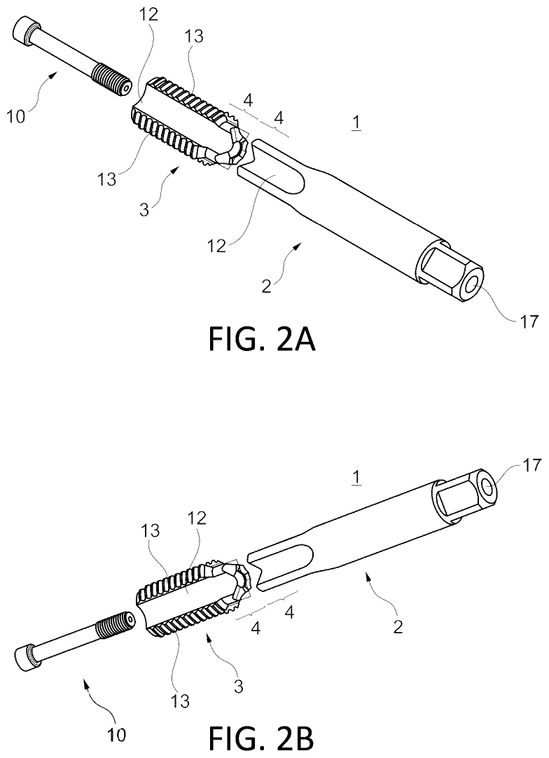

FIG. 2A and FIG. 2B show perspective views of the metal-cutting tool from FIG. 1 in exploded illustrations;

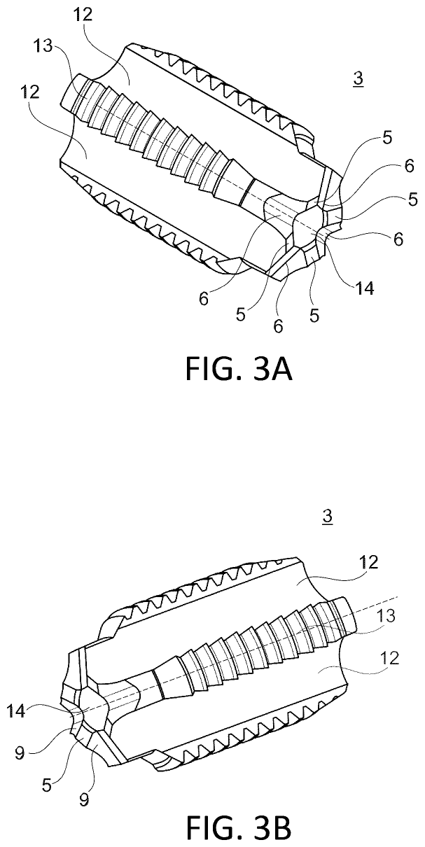

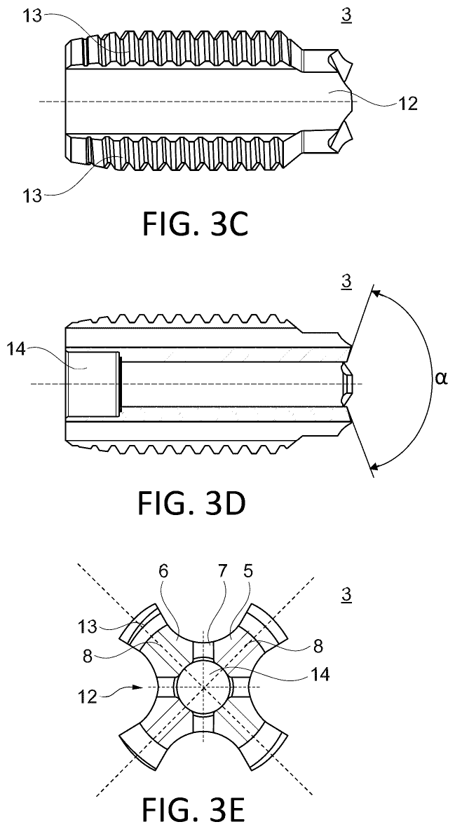

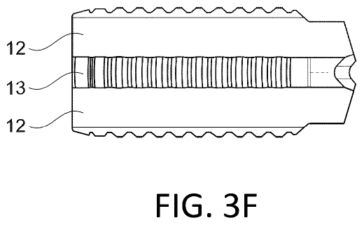

FIG. 3A to FIG. 3F show different views of the tool head of the metal-cutting tool from FIG. 1;

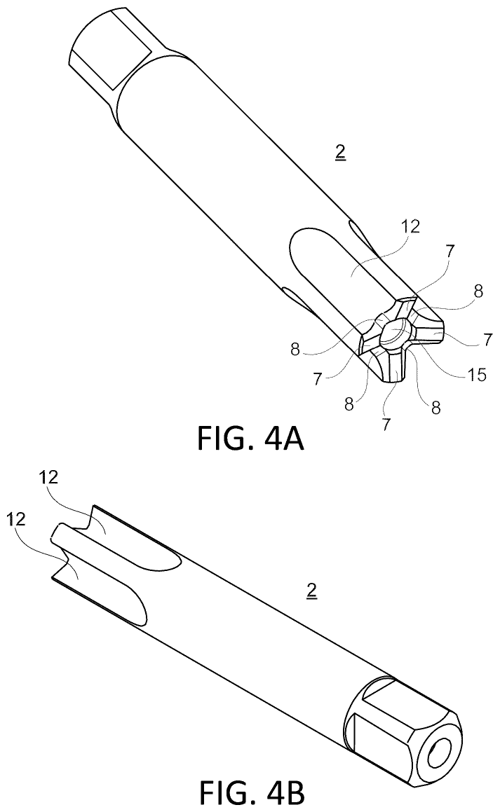

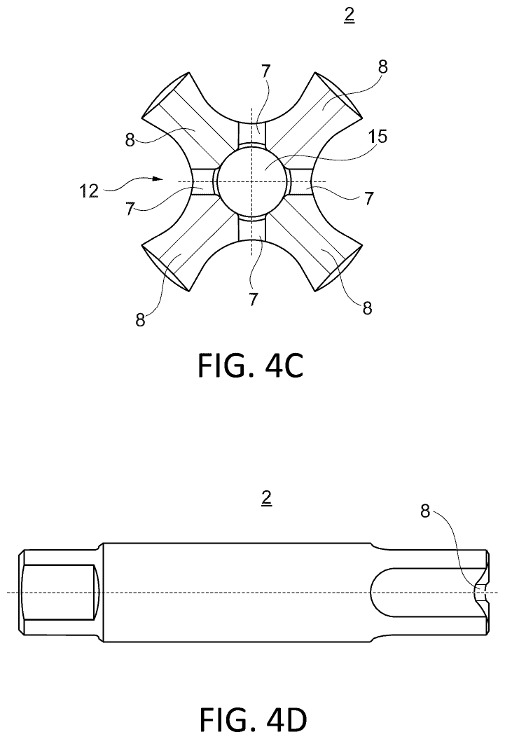

FIG. 4A to FIG. 4D show different views of the base body of the metal-cutting tool from FIG. 1;

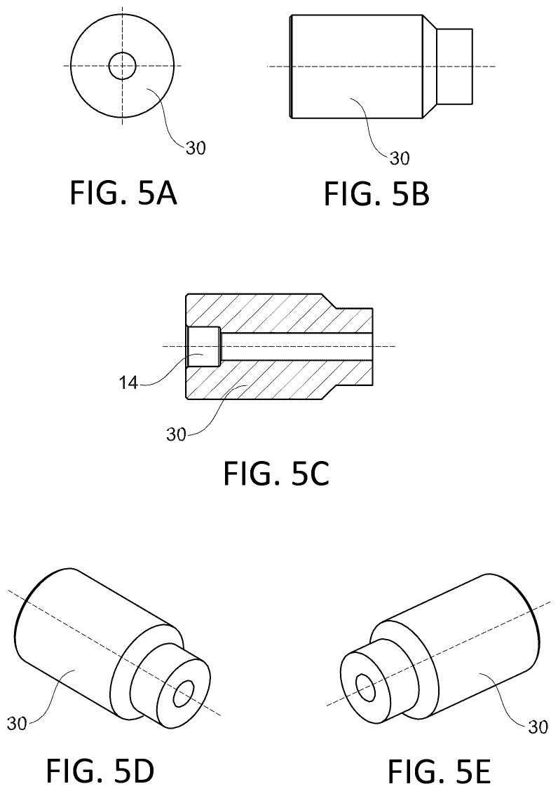

FIG. 5A to FIG. 5E show different views of a tool head blank of the metal-cutting tool from FIG. 1;

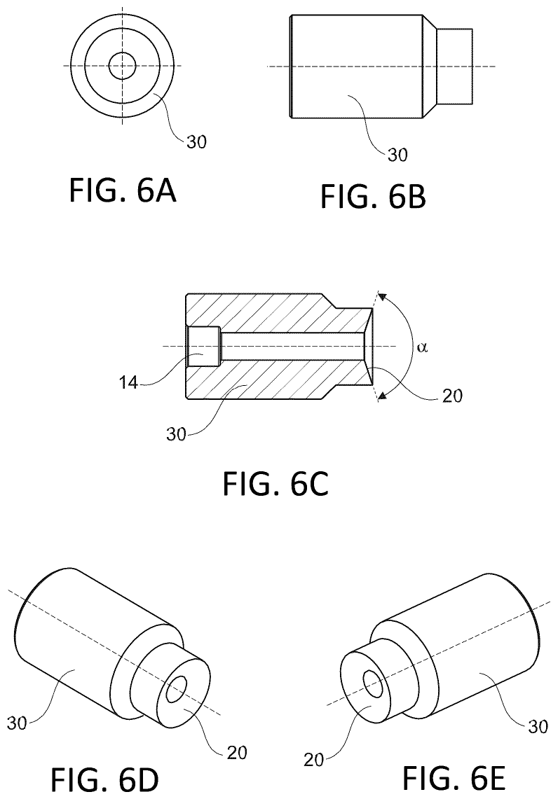

FIG. 6A to FIG. 6E show different views of the tool head blank from FIG. 5A to FIG. 5E with an inner cone, which opens on the front side;

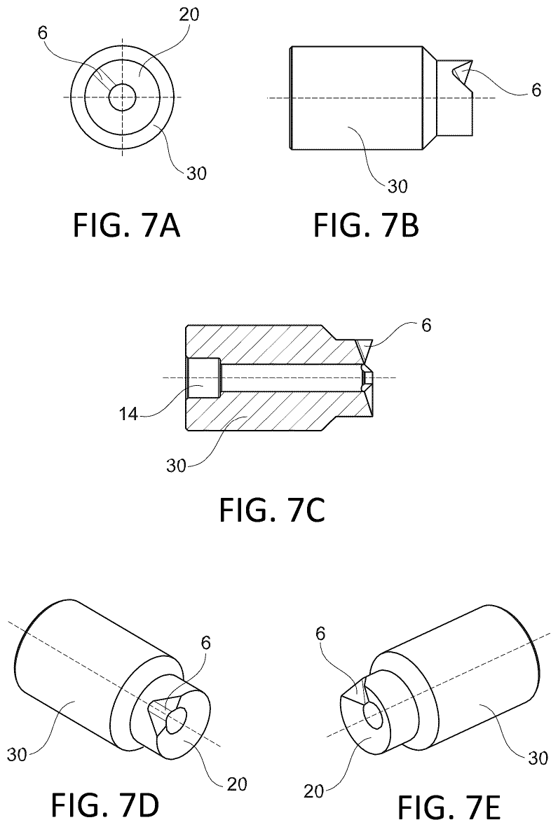

FIG. 7A to FIG. 7E show different views of the tool head blank from FIG. 6A to FIG. 6E with a tooth gap;

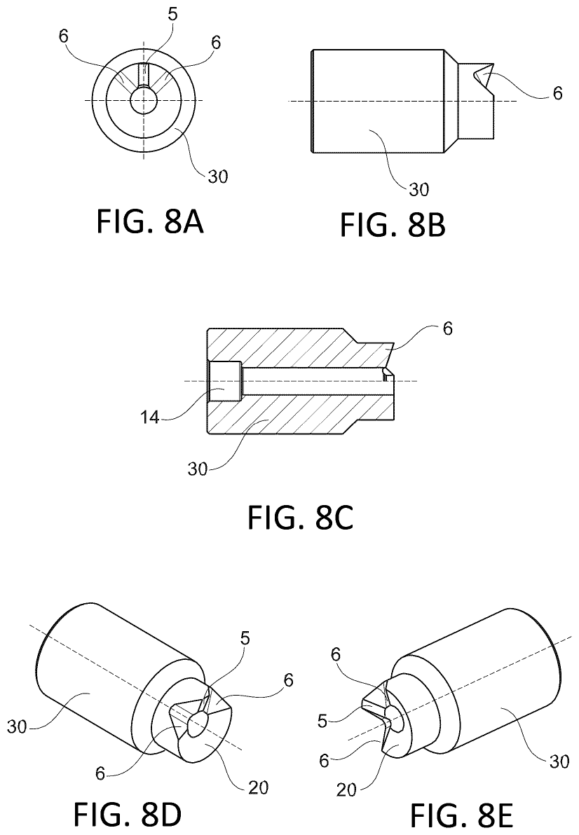

FIG. 8A to FIG. 8E show different views of the tool head blank from FIG. 7A to FIG. 7E with two tooth gaps and one tooth;

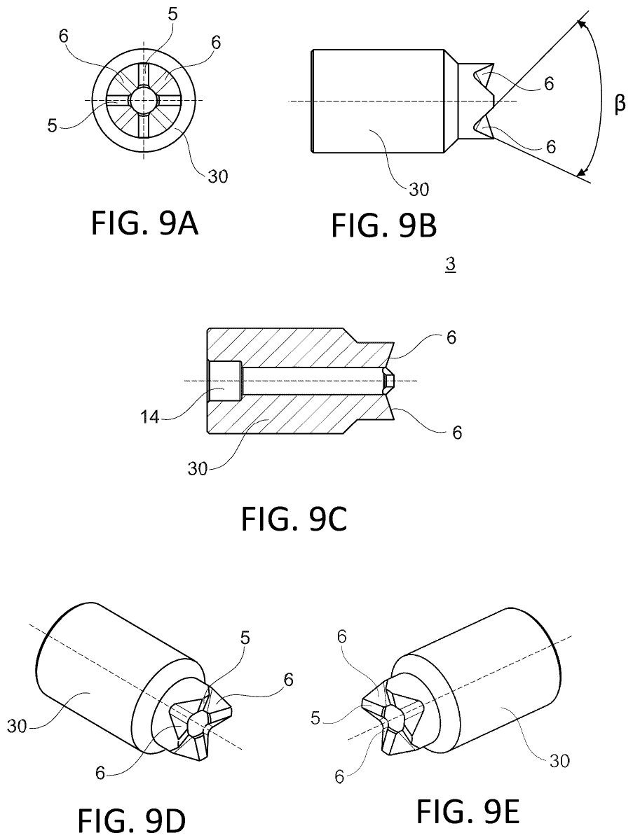

FIG. 9A to FIG. 9E show different views of the tool head blank from FIG. 8A to FIG. 8E with four tooth gaps and four teeth;

FIG. 10A to FIG. 10F show different views of a tool head blank of a second embodiment of a modular metal-cutting tool; and

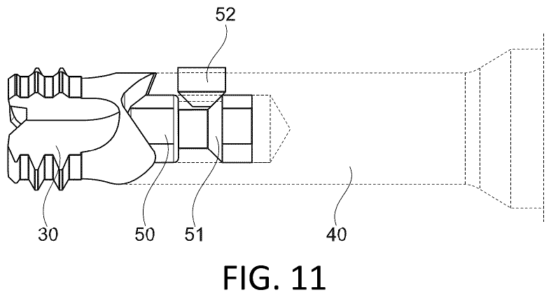

FIG. 11 shows a modified embodiment of a metal-cutting tool.

### FIRST EMBODIMENT

FIG. 1 shows a first embodiment of a modular metal-cutting tool 1 in the shape of a thread milling tool. According to FIG. 2A and FIG. 2B, the metal-cutting tool 1 is made up of a base body 2 extending along a longitudinal central axis or tool axis, respectively, a tool head 3, which is axially clamped in a positive manner against the base body 2, and a clamping screw 10, which fastens the tool head 3 to the base body 2.

In the first embodiment, the tool head 3 has four thread cutting bars 13, which are separated from one another by clamping slots 12. As it is shown in FIG. 1, FIG. 2A and FIG. 2B, the clamping slots 12 taper off in the base body 2. On its longitudinal end portion, which faces away from the tool head 3, the base body 2 forms a shank for clamping and holding the thread milling tool in a tool holder. As in the case of the shank, the thread cutting bars 13 and clamping slots 12 are design features, which are known per se, so that these features do not need to be explained further.

In the first embodiment, the base body 2 is made of a tool steel and the tool head 3 is made of solid carbide or ceramic.

The clamping screw 10 fastens the tool head 3 to the base body 2. As it is shown, for example, in FIG. 3C, the tool head 3 has, for this purpose, a radially central stepped bore 14, in which the clamping screw is arranged so as to be axially supported with its screw head. The threaded portion of the clamping screw 10 is screw-connected in the base body 2 in a radially central threaded bore 15, which axially adjoins the stepped bore. The axially opposite ends of the stepped bore 14 and threaded bore 15 can each have a chamfer, which is created by means of a processing by means of countersinking.

The positive connection between the tool head 3 and the base body 2 is achieved by means of front toothings 4, which are engaged with one another and which are formed in a complementary manner, on the axially opposite front sides of the tool head 3 and of the base body 2.

In the first embodiment, the front toothings 4 each have four teeth 5, which are distributed equidistantly around the tool axis, run radially and are separated from one another by tooth gaps 6. The teeth 5 and therefore also the tooth gaps 6 are thus arranged radially, starting from the tool axis, in such a way that two teeth 5 in each case lie diametrically opposite one another.

In other words, the teeth 5 and therefore also the tooth gaps 6 of each front toothing, in particular the angle bisectors thereof, extend into the longitudinal sectional planes of the metal-cutting tool 1, which include the tool axis, i.e., radially, viewed in the axial direction. A tooth gap 6 is the recessed region between the tooth flanks 9 of two teeth 5, which lie next to one another in the circumferential direction of the tool or rotational direction of the tool.

The tooth tip surfaces 7 of the teeth 5 of the front toothings 4 in each case lie on a virtual inner conical surface in the tool head 3 or base body 2 with the tool axis as cone axis. The tooth tips thus run from radially outside to radially inside at an angle, which is contingent on the cone angle a (see FIGS. 3D, 6C) of the inner conical surfaces, obliquely to the tool axis or to a tool cross sectional surface, respectively. The tooth height of the teeth 5 thus increases from radially inside to radially outside for each front toothing 4.

The tooth tip surfaces 7 are rounded concavely so as to correspond to the inner conical surfaces. The tooth thicknesses of the tooth heads of the teeth 5, which are measured in the circumferential direction of the tool, follow from the tooth gap recesses, which separate the teeth 5 from one another. As shown, for example, in FIG. 3A, FIG. 3E, FIG. 4B and FIG. 4D, the tooth tip surfaces 7 of the teeth 5 of each front toothing have tooth thicknesses, which remain constant over the tooth width, which is measured in the radial direction.

The base surfaces 8, concretely the angle bisectors thereof (suggested in a dashed manner in FIG. 3E), of the tooth gaps 6, which lie between the teeth 5, of each front toothing 4 furthermore lie on a virtual outer conical surface in the tool head 3 or base body 2 with the tool axis as cone axis. The angle bisectors and thus the base surfaces 8 of the tooth gaps 6 thus run in opposite direction to the tooth tip surfaces 7 obliquely to the tool axis or to a tool cross sectional plane (see the angles γ in FIG. 10F with regard to this), so that the depth of the tooth gaps 6 increases from radially inside to radially outside.

The amount of the angle of the outer conical surface relative to the tool axis or to a tool cross sectional plane, respectively, is equal to the amount of the angle of the inner conical surface relative to the tool axis or tool cross sectional plane, respectively. In the first embodiment, the amount of the angle of the outer conical surface and the amount of the angle of the inner conical surface to a tool cross sectional plane of the metal-cutting tool are 19.64°. In the first embodiment, the opening angle β of the tooth gaps or of two tooth flanks lying next to one another in the circumferential direction is 90°.

In In the state shown in FIG. 1, in which the front toothings 4 engage in a positive manner with one another on the tool head 3 and base body 2, the teeth 5 abut completely against one another exclusively on their tooth flanks 9, thus on the tooth flank surfaces, which extend from the tooth tip surfaces 7 all the way to the base surfaces 8 of the tooth gaps 6.

FIG. 2A and FIG. 2B show that the tooth tips of the front toothing 4 on the tool head 3 in each case lie in the region of a clamping slot 12, viewed in the circumferential direction of the tool. Vice versa, the tooth tips of the front toothing 4 on the base body 2 in each case lie in the region between two clamping slots 12 tapering off in the base body 2, viewed in the circumferential direction of the tool. Compared to the extension length of the teeth 5 on the base body 2, the extension length of the teeth 5 on the tool head 3, which is measured from radially inside to radially outside, is thus shortened. This distribution of the teeth 5 on the tool head 3 and in the base body 2, however, is not mandatory, so that the tooth tips of the front toothing 4 on the tool head can in each case lie in the region between two clamping slots 12, viewed in the circumferential direction of the tool, and the tooth tips of the front toothing 4 on the base body 2 can in each case lie in the region of a clamping slot 12, which tapers off, viewed in the circumferential direction of the tool.

A radially central bore, which passes through the base body 2 all the way to the shank end, axially adjoins the above-mentioned threaded bore in the base body 2. FIG. 1, FIG. 2A and FIG. 2B show the bore opening 17, which lies on the shank end facing away from the tool head. Branch bores (not shown), which, in the first embodiment, lead into joining gaps between the front toothings on the tool and base body 2, branch off towards the tool head 3 from the central bore. These joining gaps result from the concavely rounded tooth tip surfaces 7 and the axially opposite concavely rounded base surfaces 8 of the tooth gaps 6. These joining gaps can be used as channels in order to guide cooling lubricant supplied via the central bore, which lies in the base body 2, to the tool jacket side to the outside or vice versa, e.g., in response to a vacuum application, in order to guide chips from radially outside to radially inside and to discharge them via the central bore in the base body 2.

With the branch bores, the central bore thus forms a channel system formed in the base body 2, which can serve, for example, for the cooling lubricant supply of the tool head 3 or for the chip removal.

The production of the front toothings 4 on the tool head 3 and base body 2 is explained with the help of FIG. 5A to 9E. FIG. 5A to 9E show method steps for the production of the front toothing 4 on the tool head 3. The complementary front toothing 4 on the base body 3 can be produced analogously to the front toothing 4 on the tool head 3.

FIG. 5A to FIG. 5E initially show different views of a tool head blank 30, which has not been processed yet, of the thread milling tool. The front-side end of the tool head blank 30 is initially formed in a blunt manner as a circular ring-shaped front surface. Analogously, the front-side end, which faces the tool head 3, of a (non-illustrated) base body blank is initially formed in a blunt manner as a circular ring-shaped front surface.

FIG. 6A to FIG. 6E show the tool head blank 30, into the front-side end of which, which faces the base body 2, an inner cone 20 is introduced, which opens on the front side, with the tool axis as cone axis. The inner cone 20 can be created by means of a machining manufacturing method, for example with the help of a contoured milling, countersinking or grinding tool, which corresponds to the inner cone 20, or a non-cutting manufacturing method, for example by means of eroding. Analogously, an identically formed inner cone is introduced into the front-side end of the base body blank facing the tool head 3

As it is outlined in FIG. 7A to FIG. 9E, the end portions of the tool head blank and base body blank, which are provided with the inner cones 20, are further processed gradually by means of machining or by means of non-cutting in such a way that a number of tooth gaps 6 corresponding to the number of teeth 5 for each front toothing 4 is recessed. The tooth gaps 6 can be introduced, for example, with the help of a contoured milling or grinding tool, which corresponds to the opening angle of the tooth gaps 6 and which is introduced into the blanks from radially outside to radially inside. In the first embodiment, the opening angle β is 90°, for example.

The tooth gaps 6 are in particular recessed in such a way that the base surfaces 8 of the tooth gaps 6 lie on a virtual outer cone with the tool axis as cone axis and so as to be rounded concavely. The amount of the cone angle of the virtual outer cone is as large as the amount of the cone angle a of the inner cone 20.

The remaining conical surfaces of the inner cones 20, which remain after the formation of the tooth gaps 6, form the tooth tip surfaces 7 of the teeth 5 of the front toothings 4 on the tool head 3 and base body 2. Provided that no further finishing of the tooth tips takes place, the tooth tip surfaces 7 are thus formed concavely so as to correspond to the inner cone surfaces.

The tip surfaces of the teeth 5 and the base surfaces 8 of the tooth gaps 6 thus run at different signs, i.e., in opposite directions, but at an angle of identical size.

### SECOND EMBODIMENT

FIG. 10A to FIG. 10F show a second embodiment of a modular cutting tool 40. The second embodiment essentially differs from the first embodiment only in that the front toothings 4 on the tool head 3 and base body 2 in each case have three teeth 5 or tooth gaps 6, respectively.

The tooth flanks 9 of two teeth lying next to one another in the circumferential direction of the tool draw an opening angle β of, for example, 120°, as it is shown in FIG. 10E. As in the first embodiment, the cone angles are, for example, 19.64° On their radially end portions, the tooth tips have a chamfering 32, as shown in FIG. 10D.

FIG. 10F shows a tooth 5 and a tooth gap 6 lying diametrically opposite the tooth 5. The tooth tip surface 7 of the tooth 5 and the base surface 8 of the tooth gap run at an angle y, the amount of which is identical, obliquely to a tool cross sectional plane of the cutting tool.

### MODIFICATIONS

FIG. 11 sows a modified embodiment, in which the tool head is not fastened to the base body by means of a clamping screw, which is screwed into the tool head on the front side. Instead, a connecting bolt 50 is provided, which, on the one hand, is screw-connected to the tool head 30 on the base body side and which, on the other hand, is anchored, for example screw-connected, in a blind hole formed in the base body 40. The connecting bolt 50 has a conical surface 51, which cooperates with a conical surface of a cylinder screw 52, which is screwed into the base body 40 from radially outside, in order to clamp the tool head 30 to the base body 40. It goes without saying that the fastening shown in FIG. 11 can also be applied in the case of the cutting tool of the first embodiment.

The cutting tool can be embodied as a drilling, milling, threading or frictional tool and can therefore have a tool head, which is designed for a drilling, milling, threading or frictional processing.

Depending on the design of the cutting tool, clamping slots are not absolutely necessary. Provided that the cutting tool has a milling head, for example, i.e., no clamping slots are present, which run beyond the interface between tool head and base body, the front toothings on the tool head and base body can be formed identically and the teeth of each front toothing can in each case end on a tool jacket side.

In the case of a cutting tool with clamping slots, the latter can taper off axially in front of the front toothing on the tool head and base body, whereby the front toothings on the tool head and base body can be formed identically.

Deviating from the first embodiment shown in FIG. 2A and FIG. 2B, the teeth can be distributed on the tool head and base body so that the tooth tips of the front toothing on the tool head in each case lie between two clamping slots, viewed in the circumferential direction of the tool, and the tooth tips of the front toothing on the base body in each case lie in the region of a clamping slot, which tapers off, viewed in the circumferential direction of the tool.

1. A modular cutting tool with a base body extending along a tool axis and a tool head connected via a positive coupling to the base body, wherein the positive coupling is formed from front toothings, which are engaged with one another, on the base body and the tool head, which each have a plurality of radially running teeth, which are distributed equidistantly around the tool axis, and
for each front toothing, the tip surfaces of the teeth lie on an inner conical surface in the tool head or the base body with the tool axis as cone axis, and the tip surfaces of the teeth are rounded concavely.

2. The cutting tool according to claim 1, wherein for each front toothing angle bisectors of base surfaces of the tooth gaps lying between the teeth lie on an outer conical surface in the tool head or base body with the tool axis as cone axis.

3. The cutting tool according to claim 2, wherein an amount of an angle of the outer conical surface relative to a tool cross sectional plane is equal to an amount of an angle of the inner conical surface relative to a tool cross sectional plane.

4. The cutting tool according to claim 1, wherein a tooth thickness measured at a height of the tip surfaces of the teeth remains the same size beyond the respective tooth width of the teeth.

5. The cutting tool according to, claim 1, wherein the front toothings on the base body and the tool head abut against one another exclusively on tooth flanks of their teeth.

6. The cutting tool according to claim 5, wherein axial gaps between the tip surfaces of the teeth and base surfaces of the tooth gaps of the front toothings, which are engaged with one another, form cooling lubricant-guiding and/or dirt-discharging channels.

7. The cutting tool according to claim 1, wherein the tool head is fastened to the base body by means of a centrally arranged clamping screw, which passes through a screw hole in the tool head and which is screwed into a threaded bore in the base body.

8. The cutting tool according to claim 1, wherein the teeth of the front toothing on the tool head are arranged around the tool axis so that they in each case end radially outwards in a clamping slot formed on the tool head.

9. The cutting tool according to claim 1, wherein each front toothing comprises an even number of teeth.

10. The cutting tool according to claim 1, wherein each front toothing comprises an odd number of teeth.

11. The cutting tool according to claim 1, wherein for each front toothing, tooth flanks of two teeth adjacent to one another in a circumferential direction of the cutting tool draw a tooth gap opening angle in the range of 80° to 120°.

12. A method for establishing a positive coupling between a base body and a tool head of a modular cutting tool according to claim 1,
wherein an inner cone opening on a front side is in each case initially introduced into a base body blank and into a tool head blank with the tool axis as cone axis, and
a plurality of recesses forming the teeth and the tooth gaps lying between the teeth are subsequently introduced into the base body blank and tool head blank, which is processed in this way, in each case from radially outside to radially inside.

13. The cutting tool according to claim 1, wherein each front toothing comprises four teeth.

14. The cutting tool according to claim 1, wherein each front toothing comprises three teeth.
